(19) United States
(12) Patent Application Publication
(10) Pub. No.: US 2023/0240276 A1
(43) Pub. Date: Aug. 3, 2023

(54) Tackle Box for Tandem Rigs

(71) Applicant: James Christopher Tremper, Fredericksburg, VA (US)

(72) Inventor: James Christopher Tremper, Fredericksburg, VA (US)

(21) Appl. No.: 17/590,756

(22) Filed: Feb. 1, 2022

(51) Int. Cl. A01K 97/06

(52) U.S. Cl. CPC A01K 97/06

(57) ABSTRACT

A tackle box specifically designed to accommodate a fully assembled tandem fishing rig consisting of two different lengths of fishing line and two different baits. The revolutionary tackle box consists of two individual compartments, one each to hold one of the two baits, and a unique line-winding track joined to each compartment to accommodate the individual fishing lines. The line-winding tracks are further separated by a precisely placed line-winding track divider to provide the user a tangle-free experience. Strategically placed slots provide retention of the fishing lines of the terminal tackle and the baits. These components combine to create a one-of-a-kind tackle box purposefully and uniquely designed to facilitate the safe, tangle-free and organized loading, unloading, winding, unwinding and the storage of the separate fishing lines and baits of the tandem rig.

### CROSS-REFERENCE TO RELATED APPLICATIONS

Not Applicable

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

“Tandem Rigs” are a commonly used rig in the fishing industry and can be comprised of several types of lures. The tandem rig itself consists of a three-way swivel in which one of the three anchoring points of the swivel is attached to the main fishing line from the reel of the angler's fishing rod. The other two anchoring points of the three-way swivel are for the attachment of two different lengths of fishing line, which terminate at two different baits. One line is generally twice the length of the other and is rigged with a much lighter bait than the other bait in the rig, which ensures that it travels higher in the water column so it will not tangle with the second bait while trolling is underway. The second line is traditionally half the length of the first and is tied to a heavier bait, which will travel lower in the water column, again, to prevent the two tangling together while underway. Any length, color, brand or weight of line can be used and is inconsequential to the set-up of the rig.

The two baits used for the tandem rig can be of any type of bait manufactured or otherwise produced, and the size or type of bait in inconsequential to the set-up of the rig provided one bait is half the weight or so of the other. Once the rig is tied and ready to fish, it is released into the water at a slow trolling speed and trolled by the boat through the water in hopes of hooking fish.

While tandem rig “kits” can be purchased at a premium price, many times, due to price or rig component preference(s), the components of the rig are purchased individually and must be assembled by, and storage space found for, the rig by the angler. Assembly can be expensive, tedious and time-consuming, and finding secure storage on boats for such a rig is difficult.

Proper care and storage of these rigs is a challenge due to the complexity of the multiple fishing lines and the two baits working in tandem, and many methods have been tried and proven woefully ineffective in keeping the bait secure, protected and ready for future use. When deployed and/or retrieved, the two lines and two baits must be addressed at the same time yet independent of each other. If done incorrectly and without proper gear, tangling of the lines can be inevitable and addressing the two hook bodies can be dangerous, particularly since they are coming out of the water at different intervals.

Safe handling of these rigs presents many challenges due to the three-way swivel hardware, the long lengths of line, and the razor-sharp hooks, which can cause personal injury as well as damage to boats, equipment and clothing. It should be pointed out that all the while the apparatus is being tied, loaded with hooked baits, released and retrieved, it is being done aboard a moving vessel, and the consequences of unsafe rig practices can be painful and damaging.

While the tandem rig has been used for decades, until now safe and effective storage for them has always been a common and frustrating problem. This has lead most anglers to disassemble, or “disarm,” the rig after use. This is time-consuming and costly, and renders the rig useless until it is re-rigged.

Many items on the market today could probably be used to simply store a tandem rig; however, not one of them addresses the specific and unique issues related to the safe use and storage of the rig. There is no product available at this time which offers a solution to the safe and tidy retrieval of the multiple fishing lines, thereby preventing the chaffing and tangling of said lines or the potentially dangerous action of deploying and/or retrieving the rig, thereby protecting the angler and their property. Further, nothing currently addresses storing the rig in a readily usable or “loaded” fashion while protecting the terminal tackle, line and baits from the effects of weather or abuse from the harsh rigors of use in a rough environment aboard a boat, thereby saving the angler valuable time and money.

From an ecological standpoint, by addressing these issues and allowing for the safe use and storage of the “loaded” tandem rig, anglers will not be required to disassemble the rigs after each use which will result in less used, and less wasted fishing line, which is likely to be a positive for our oceans, rivers, lakes and streams.

The present art/invention contained in this application specifically addresses and uniquely overcomes and resolves all of the issues that present a challenge to the safe use of, the deployment and retrieval of, and the safe storage of the tandem rig, along with allowing the rig to remain fully rigged and ready to fish at all times.

### BRIEF SUMMARY OF THE INVENTION

The present art/invention contained in this application addresses and resolves the deficiencies of any prior art which attempted to allow the safe, methodical and orderly deployment or retrieval of the tandem fishing rig. It accomplishes this by providing unique and specific locations for the fishing line and the baits used, coupled with a particular winding process that eliminates the possibility of the two lines entangling one another. The invention further provides a safe means of deployment and retrieval of the tandem rig while still securely hooked to the main trolling line, thereby preventing the possibility of a “late-strike” fish taking off with the bait(s) and line(s). It does this by providing anchor points for the terminal tackle and the individual lines of the rig, along with a firm grip on the tackle box for the angler. This allows for the safe deployment, retrieval, and storage of the tandem rig in a boat-friendly container, fully rigged and ready for the next trip.

### BRIEF DESCRIPTION OF THE SEVERAL FIGURES OF THE DRAWINGS

FIG. 1 shows an unobstructed view of the tackle box from this invention, in full detail, from an elevated view from the top-front.

FIG. 2 shows the tackle box from this invention, in full detail, from an elevated view from the top-front, with the features located and numbered.

FIG. 3 shows an unobstructed view of the tackle box from this invention from the top view.

FIG. 4 shows the tackle box from this invention from the top view, with the features located and numbered.

FIG. 5 shows an unobstructed view of the tackle box from this invention from the front/bottom, slightly tipped up in the front to enhance the detail(s)

FIG. 6 shows the tackle box from this invention from the front/bottom view, slightly tipped up, with the features located and numbered.

FIG. 7 shows an unobstructed view of the tackle box from this invention from the front view.

FIG. 8 shows an unobstructed view of the tackle box from this invention from the rear view.

FIG. 9 shows the tackle box from this invention from the front view with the features located and numbered.

FIG. 10 shows a view of the tackle box from this invention from the rear view with the features located and numbered.

FIG. 11 shows the tackle box from this invention with an impression of a fully rigged and loaded tandem rig from a top view looking directly down into the tackle box.

FIG. 12 shows the tackle box from this invention with an impression of a fully rigged and loaded tandem rig from a top-front view looking down into the tackle box.

FIG. 13 is included for the sole purpose of education and clarity regarding the components of a traditional tandem rig along with all of its features being located and numbered. It is not part of the invention; it only illustrates the invention's intended use.

FIG. 14 is the legend for all drawings. All numbers and letters from the legend correspond directly to all of the drawings.

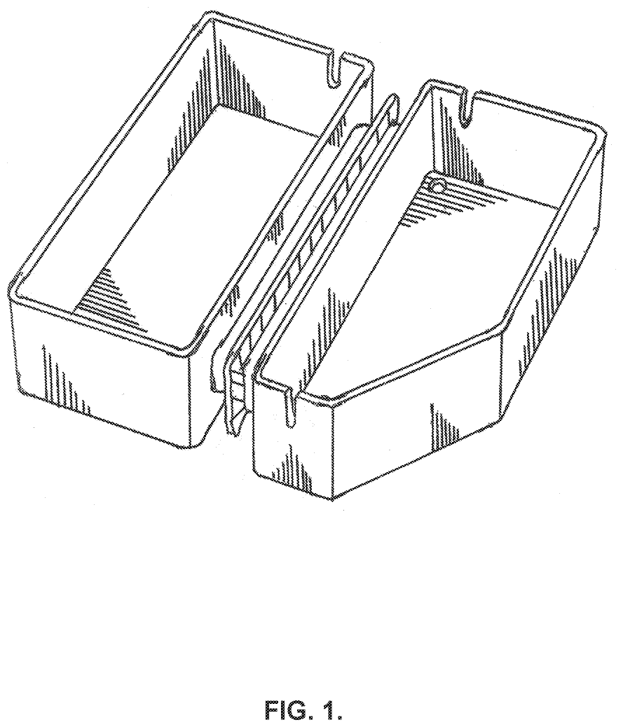

### DETAILED DESCRIPTION OF THE INVENTION

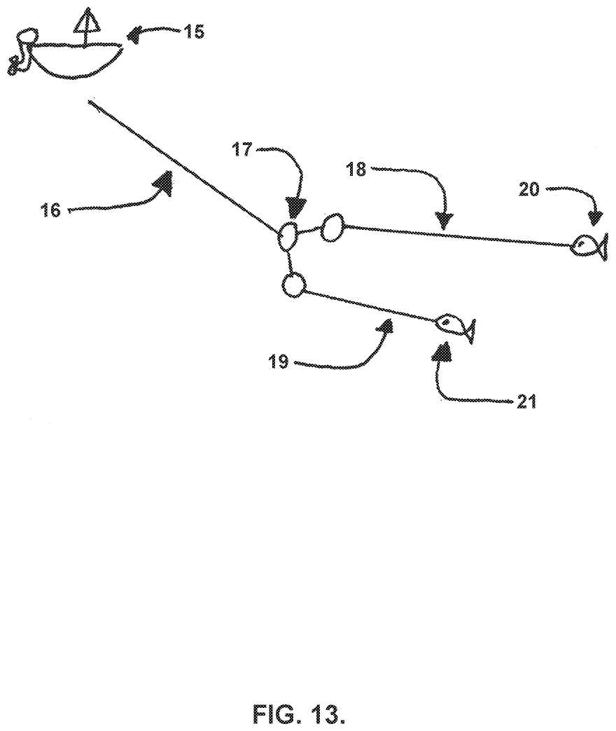

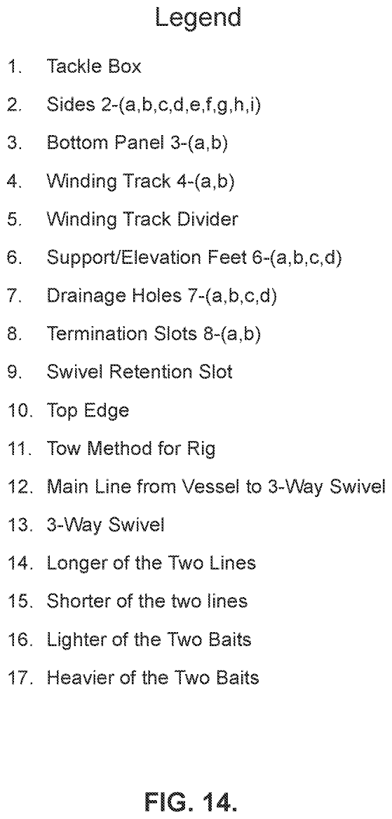

The most important and unique quality of the art/invention contained herein lies in the ability of the invention to permit a tandem rig (FIG. 13) to be loaded (terminal tackle, multiple hooks and two fishing lines), deployed, retrieved and properly and safely stored, without any tangling of the lines, damage to the rig, boat or the angler. No prior art/invention has been able to accomplish that feat, while all of these goals are accomplished in this one item. How it is accomplished by the art/invention in this application is completely and fully explained in the following text.

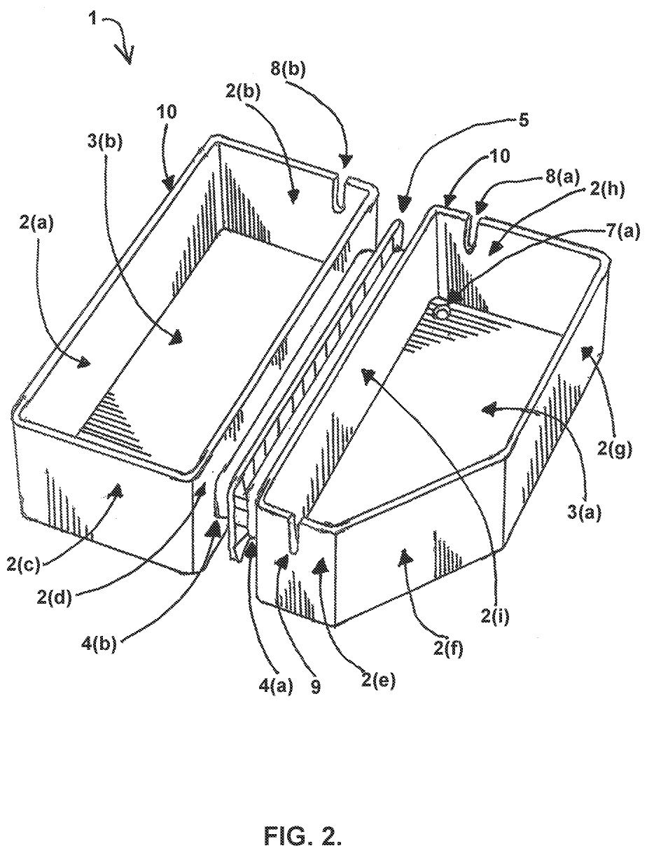

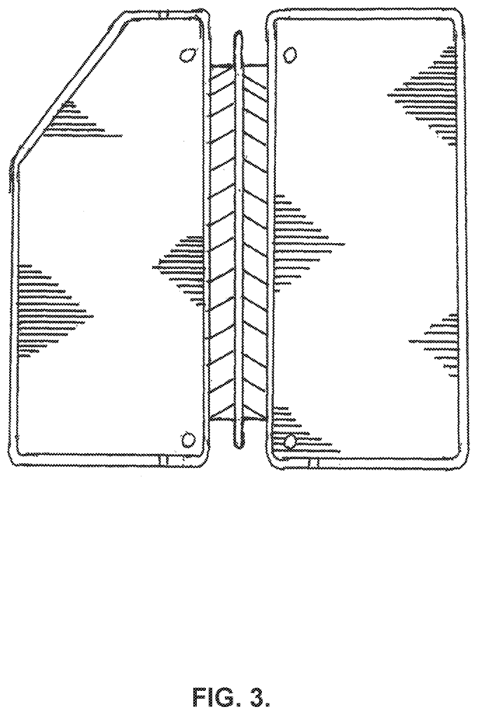

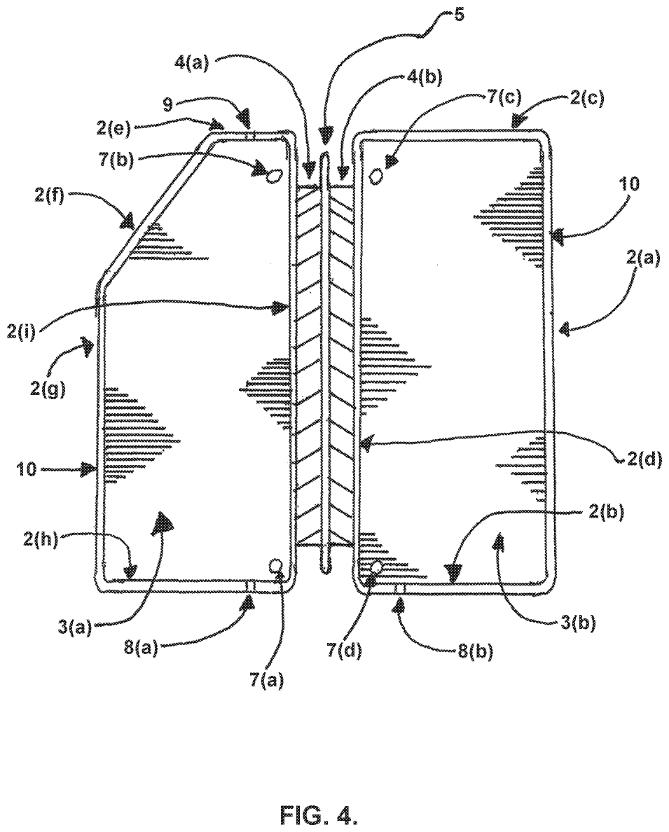

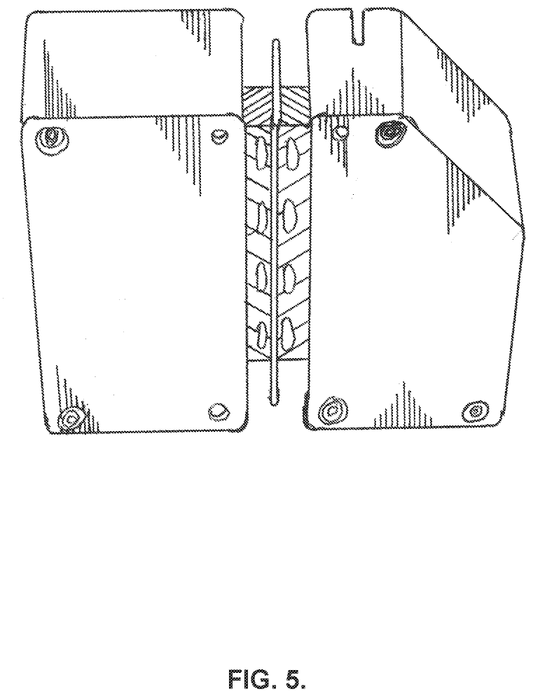

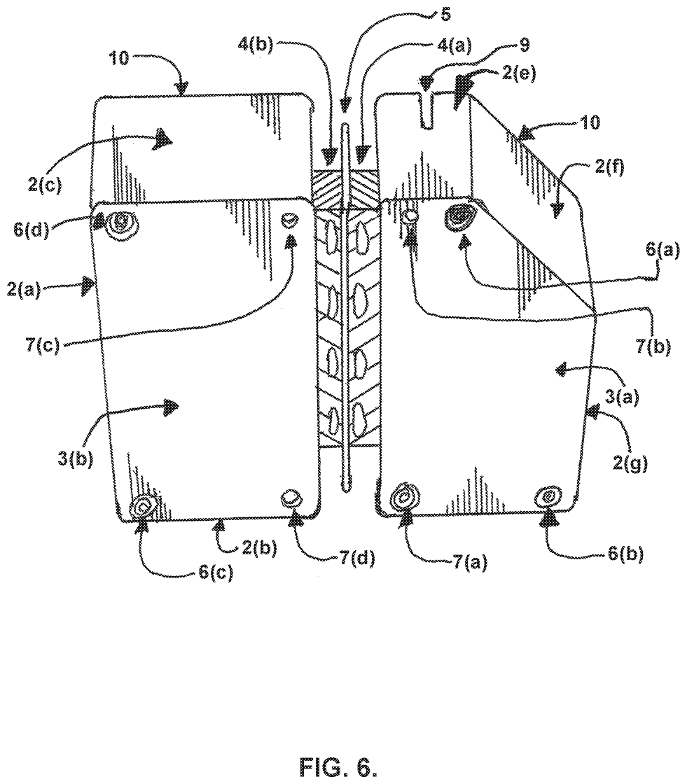

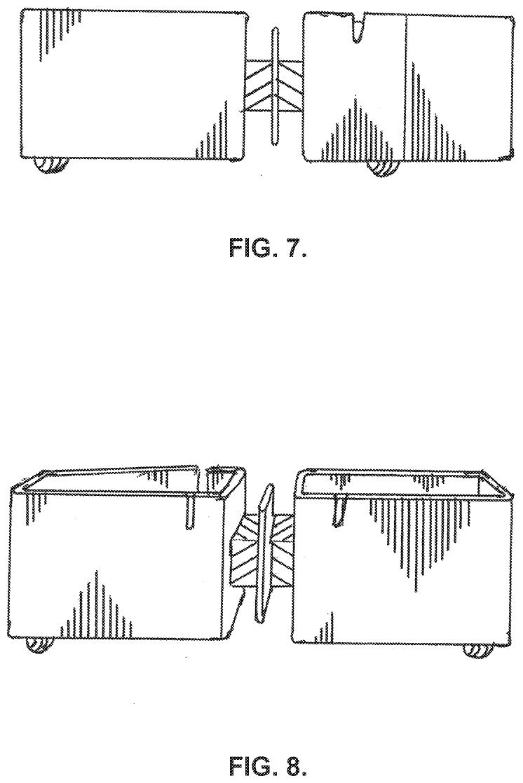

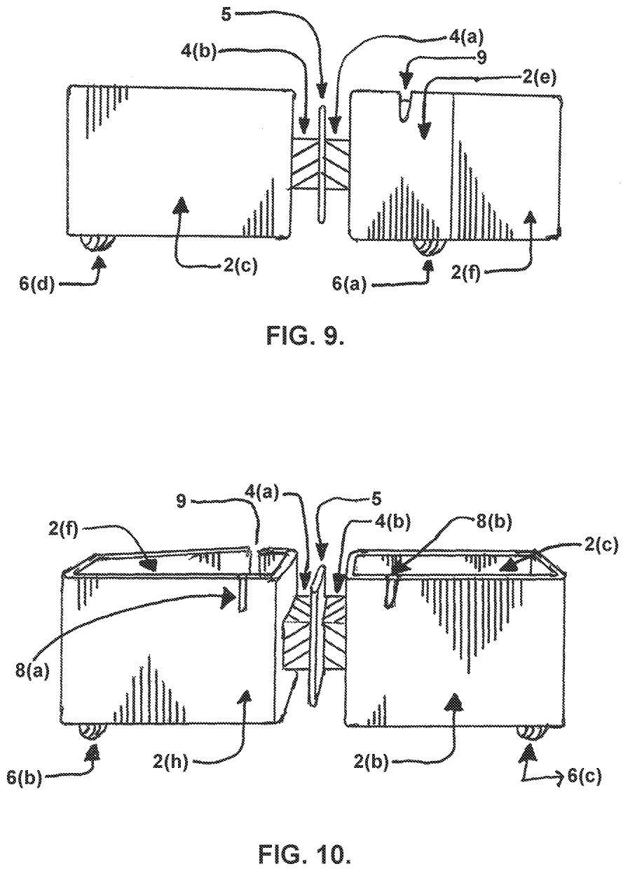

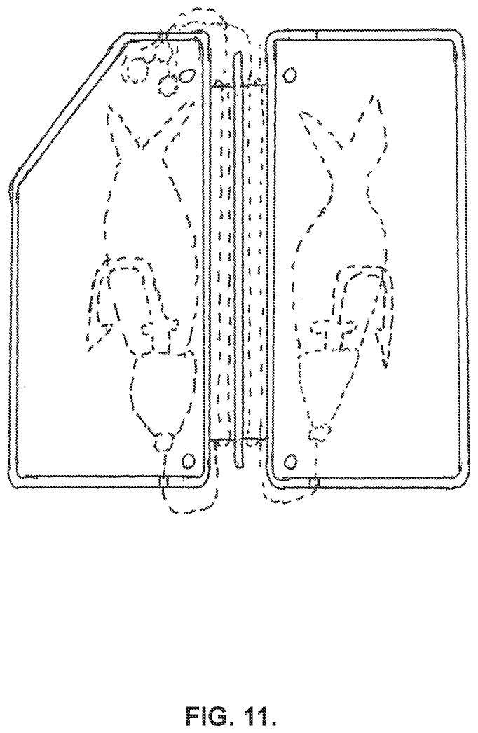

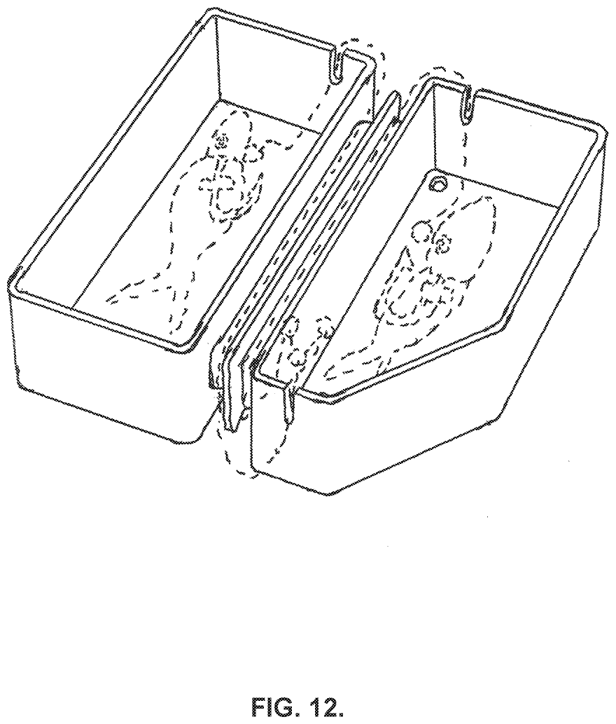

Referring to FIG. 2. The tackle box (1) is made from nine sides (2a through 2i) and two bottom panels (3a and 3b) to create two distinct compartments with a top edge (10). It is important to note that the number of sides per compartment can be less than or greater than nine and could form any shape, including round, oval or other, that can be created to form the two distinct compartments. Neither the configuration nor the size of the compartments will affect the invention's intended use.

Referring to FIGS. 2 and 13. The uniqueness of the thought, design and structure behind keeping the lines tangle-free is explained further in the following text.

The two compartments formed by the sides (2a through 2i) and bottom (3a & 3b), which are designed to house and secure the two baits (16 & 17) used for the rig, are separated by two winding tracks (4a and 4b), which are in turn, divided by one winding track divider (5). This aggregate of the three parts (4a, 4b & 5) serves as a bridge between the two compartments. The two winding tracks (4a & 4b) will be used to neatly wrap the fishing lines (14 and 15) that run out from the 3-way swivel (13) to the baits (16 and 17), and the winding track divider (5) will keep the lines separate from one-another while retrieving or deploying the tandem rig, preventing any possibility of the fishing lines becoming entangled with one another.

Safely handling the rigs, which terminate with baits that in many instances contain a dozen or more hooks (in the case of crank-baits that can have as many as nine hook-points each), is also of chief concern. The tackle box in the art/invention in this application has several unique features, not found in any prior art or invention, that allow for the safe handling from the original rigging to the final storage of the tandem rig. The unique and thoughtful features of the design are fully explained in the text below.

On one end of the tackle box, and in one of the two compartments, is a swivel retention slot (9) designed to quickly, safely and easily retain the 3-way swivel of the tandem rig. When originally loading the tandem rig, the tackle box (1) is held firmly in one hand, and the 3-way swivel (13) is placed through this slot (9) and fully into the compartment, thereby securing it. The lines of the rig stay outside of the tackle box at this point. With the 3-way swivel (13) confined to the inside of the tackle box, this allows the first line to be wrapped around the winding track (4a & 4b). It should be noted that which hand is used is of no consequence as using either hand is a matter of comfort and preference to the user and will not have any effect on the invention's usability or intended purpose.

The first line wrapped will be the shorter of the two lines (15), which hosts the heavier of the two baits (17). The line will be wound around the winding track closest to the compartment that harbors the 3-way swivel (13). After the line (15) has been fully wound and there is not enough play to go around the winding track (4a & 4b) again, the line is then run through the termination slot (8a & 8b) of the compartment on the same side of the winding track used. The bait (17) is then laid into the compartment, where it is fully protected from the environment, as is the angler protected from the bait.

With the first line (15) wrapped and the bait (17) secured, the angler can now wrap the second line (14) securely around the opposite winding track (4a & 4b). The process is the same as that used for winding the first line (15) and bait (17). The angler will wrap the second line (14), which is the longer line and hosts the lighter bait (16), around the winding track (4a & 4b) until it can no longer be fully wound around. At this time, the longer line (14) hosting the lighter bait (16) will be run through the termination slot (8a & 8b) of the opposite compartment of the first bait. The lighter bait (16) is now safely stowed away, same as the first. The process of loading the tackle box (1) is simple, safe and quick, and the unique and revolutionary design of the winding tracks (4a & 4b), coupled with the simple, yet ingenious winding track divider (5) guarantees that if done correctly, the lines will remain untangled.

Referring to FIGS. 2 and 13. The deployment of the tandem rig from the tackle box (1) art/invention herein is made safer and more simple than ever before by the nature of the invention.

Ideally, the rig would be deployed by first hooking the swivel from the fishing rod of the angler to the proper ring of the 3-way swivel (3) of the tandem rig and securing the rod into a rod holder before completing the following process. Doing so is possible due to the unique design of the tackle box (1) and the precise process of loading the rig originally. However, the rig can also be quickly and safely deployed by simply holding the tackle box (1) firmly in one hand, which hand is a matter of comfort and preference and has no bearing the invention's performance or usefulness, and simply reversing the process followed when loading the rig into the tackle box (1). In either event, the process for deploying the rig itself is the same.

The lighter, longer-lined, bait (16) will be released first by simply unwinding it from the winding track (4a & 4b) into the water and allowing the bait (16) to swim out behind the boat (11) as the boat moves forward in a slow troll. After it has fed out completely, the heavier bait (17) and shorter line (15) can be fed out in the same manner. By allowing the angler a firm grip on the tackle box (1) and not having the fishing line in the user's bare hands, coupled with the 3-way swivel (13) securely retained in the swivel retention slot (9), there is no danger of a quick and unanticipated strike jerking the line potentially causing severe injury or lost baits and line into the water where they can wreak havoc on the creatures of the water, boat propellers or worse.

At this point, if the rig was first hooked to a fishing rod, the process is complete, and nothing further is required. If the option of hand-feeding the rig was used, now is the time to hook the rig to an available pole. Simply leave the 3-way swivel (13) in the swivel retention slot (9) until you have hooked up to a secure fishing rod.

Retrieving the rig is as simple as reeling it in until the 3-way (13) swivel can be safely grasped by the angler and immediately placed correctly into the swivel retention slot (9). The process at this point is identical to the process used when originally loading the tandem rig. Most anglers fishing in saltwater will rinse the baits with fresh water after use before storing them away to prevent corrosion from the saltwater damaging the baits. The tackle box (1) assists in this process by providing a number of drainage holes (7) to allow the wet lures to dry, and support/elevation feet (6) to help to facilitate the drying process. It is important to mention that any number of drain holes and/or support feet of one or more could be used and would not affect the use or intended purpose of the art/invention described herein.

The art/invention described herein is intended to be produced from thermoplastic by manner of injection molding as is traditional in many fishing items due to its strength, tolerance to the elements, its inexpensive nature and its ability to be processed from transparent to virtually any color. However, it should be noted that the tackle box (1) could be made of any type of material from plastic to wood to metal without changing its usefulness or intended purpose.

Also, it should be noted that while the art/invention herein is shaped to conform to a particular final package, it is fully understood that the overall size and shape can be quickly and easily changed without affecting the invention's usefulness or intended purpose. It is further understood that while the art/invention herein has been physically formatted to fit into a larger container which already exists, the tackle box (1) itself could easily be fitted with a lid or hinged top, having no effect on the design, purpose or usefulness of the art/invention described herein.

1. A tackle box which is comprised of two separate and distinct compartments, each compartment consisting of a single or multiple walls and a floor panel, and each compartment having a dedicated line-retention slot and with at least one of the compartments featuring a dedicated slot at the opposite end to retain the terminal tackle used to connect the individual parts of the rig, whereas the two aforementioned compartments are joined together with, yet set-apart by, a unique and revolutionary combination of a winding track, a winding track divider, and a second winding track, forming a complete tackle box which is designed to safely and securely deploy, retrieve and store a fully rigged tandem fishing rig with no possibility of entanglement of the tandem rig.
